(19) United States
(12) Patent Application Publication
(10) Pub. No.: US 2006/0145396 A1
(43) Pub. Date: Jul. 6, 2006

(54) Drive device for injection molding machine and molding method

(75) Inventors: Norihito Okada, Chiba (JP); Yosuke Tokui, Chiba (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: SUMITOMO HEAVY INDUSTRIES, LTD

(21) Appl. No.: 10/561,605

(22) PCT Filed: Jul. 7, 2004
(86) PCT No.: PCT/JP04/09654

§ 371 Date: Dec. 20, 2005

(51) Int. Cl. B29C 45/00

(52) U.S. Cl. 264/328.1; 425/150; 425/586; 425/587

(57) ABSTRACT

The object is to provide a drive apparatus for an injection molding machine which can increase the responsiveness of acceleration at the time of start-up of a driven portion. It has a driven portion, a transmission shaft which has a screw shaft portion and an output shaft portion and which is connected to the driven portion so as to be able to rotate with respect thereto and which can advance and retract, a nut which threadingly engages the screw shaft portion, a motor frame which is mounted on a motor mounting frame, a rotor which is mounted on the output shaft portion, and a stator which is mounted on the motor frame. A rotor is mounted on the output shaft portion of the transmission shaft, so the inner diameter of the stator can be reduced by that amount, and the outer diameter of the rotor can be decreased. Accordingly, the inertia of the drive system can be decreased, so the acceleration of the driven portion can be increased, and the responsiveness of acceleration during start-up of the driven portion can be increased. Moreover, rotation can be transmitted to the transmission shaft without using a spline, so sliding resistance due to a spline can be eliminated.

### TECHNICAL FIELD

The present invention relates to a drive apparatus for an injection molding machine and a molding method.

### BACKGROUND ART

In a conventional injection molding machine, a resin heated and melted inside a heating cylinder is injected at a high pressure to fill a cavity of a mold apparatus, and it is cooled and solidified in the cavity to obtain a molded article.

Therefore, the injection molding machine has a mold clamping apparatus, a mold apparatus, and an injection apparatus. The mold clamping apparatus has a stationary platen, a movable platen, and a mold clamping cylinder. The mold apparatus has a stationary mold and a movable mold. By advancing and retracting the movable platen by means of the mold clamping cylinder, the movable mold is caused to contact and separate from the stationary mold, whereby mold closing, mold clamping, and mold opening can be carried out.

The injection apparatus includes a heating cylinder which heats and melts resin supplied from a hopper, and an injection nozzle for injecting the molten resin. A screw is disposed in the heating cylinder so as to freely rotate and so as to be able to advance and retract. The screw is advanced so as to inject the resin from the injection nozzle, and the screw is rotated so as to meter the resin.

A drive apparatus for an injection molding machine using a metering motor and an injection motor has been proposed in order to rotate the screw and advance and retract the screw.

FIG. 1 is a cross sectional view of a main portion of a conventional injection apparatus.

In the drawing, 15 is a drive portion which rotates and advances and retracts an unillustrated screw (driven portion). The drive portion 15 has an injection frame 17, a metering motor 22 disposed inside the injection frame 17, an injection motor 23 disposed to the rear (to the right in the drawing) of the injection frame 17, and other members.

The metering motor 22 has a frame 34, a hollow output shaft 35 which is rotatably supported with respect to the frame 34, a rotor 36 which is mounted on the output shaft 35, a stator 37 which is disposed with a gap between it and the rotor 36, and other members.

During a metering step, the screw can be rotated by driving the metering motor 22. For this purpose, a spline nut 40 is mounted on the rear end (the right end in the drawing) of the output shaft 35, and a female spline 41 is formed on the inner peripheral surface of the spline nut 40. A bearing box 13 has a disc-shaped bottom portion 43 on which the rear end of the screw is mounted, and a tubular side portion 44 which extends rearwards from the outer peripheral rim of the bottom portion 43. A bearing br10 comprising a thrust bearing is housed in the interior of the side portion 44, and a male spline 45 is formed on the outer peripheral surface of the side portion 44. The female spline 41 and the male spline 45 are engaged so as to be able to slide in the axial direction while being prevented from rotating in the circumferential direction and constitute a first rotation transmitting portion.

Accordingly, at the time of a metering step, rotation which is generated in the output shaft 35 when the metering motor 22 is driven is transmitted to the bearing box 13 through the first rotation transmitting portion, and it is further transmitted to the screw. When the screw is rotated, unillustrated pellet-shaped resin is supplied from an unillustrated hopper, the resin is charged into an unillustrated heating cylinder, and it is advanced along a groove in a flight formed on the outer peripheral surface of the screw. At the same time, the screw is retracted, and one shot of resin is accumulated in front of an unillustrated screw head at the front end of the screw. At this time, with the female spline 41 and the male spline 45 engaged with each other, the bearing box 13 is retracted (moved to the right in the drawing) with respect to the output shaft 35. In this manner, metering can be carried out.

The injection motor 23 has a frame 54, a hollow output shaft 55 which is rotatably supported with respect to the frame 54 by bearings br11 and br12, a rotor 56 which is mounted on the output shaft 55, a stator 57 which is disposed with a gap between it and the rotor 56, and other members. The injection motor 23 is mounted on the injection frame 17 through a load cell 24 and a load cell retainer 25.

At the time of an injection step, when the screw is advanced without rotating by driving the injection motor 23, the resin which is accumulated in front of the screw head is injected from the injection nozzle, and it fills a cavity in an unillustrated mold apparatus. For this purpose, a ball screw shaft/spline shaft unit 61 is rotatably supported by the bearing box 13, and a thrust load applied to the ball screw shaft/spline shaft unit 61 is received by the bearing br10. A cylindrical shaft portion 62 is formed at the front end (the left end in the drawing) of the ball screw shaft/spline shaft unit 61. A ball screw shaft portion 64 is formed to the rear of the cylindrical shaft portion 62, and a spline shaft portion 68 is formed to the rear of the ball screw shaft portion 64.

The ball screw shaft/spline shaft unit 61 has its front end disposed inside the metering motor 22, it extends to the rear, and its rear end is disposed inside the injection motor 23. A ball nut 63 is mounted on the injection frame 17 through the load cell 24. The ball nut 63 and the ball screw shaft portion 64 are threadingly engaged. The ball nut 63 and the ball screw shaft portion 64 form a ball screw.

A tubular engaging portion 66 is disposed inside the output shaft 55. The engaging portion 66 is secured to output shaft 55, and a female spline 67 is formed at the front end of its interior surface. The female spline 67 and a male spline 69 formed on the outer periphery of the spline shaft portion 68 are spline engaged (see Patent Document 1, for example).
Patent Document 1: Japanese Patent Application Laid-Open (kokai) No. H11-198199

### DISCLOSURE OF THE INVENTION

### PROBLEM TO BE SOLVED BY THE INVENTION

In the above-described conventional injection apparatus, the engaging portion 66 and the ball screw shaft/spline shaft unit 61 are disposed inside the output shaft 55, so it is not possible to make the inner diameter of the output shaft 55 small, and the outer diameter of the rotor 56 ends up being large. As a result, the inertia of the drive system becomes large, and to that extent the responsiveness of the screw at the time of start-up acceleration ends up decreasing.

An object of the present invention is to solve the problems of the above-described conventional injection apparatus and to provide a drive apparatus for an injection molding machine and a molding method which can increase the responsiveness of a driven portion at the time of start-up acceleration.

### MEANS FOR SOLVING THE PROBLEM

To achieve the above object, a drive apparatus for an injection molding machine according to the present invention has a driven portion, a transmission shaft which has a screw shaft portion and an output shaft portion and which is connected to the driven portion so as to be able to rotate with respect thereto and which is disposed so as to be able to advance and retract, a nut which is threadingly engaged with the screw shaft portion, a motor frame which is installed on a motor installation frame, a rotor which is mounted on the output shaft portion, and a stator which is mounted on the motor frame.

### EFFECTS OF THE INVENTION

According to the present invention, a drive apparatus for an injection molding machine has a driven portion, a transmission shaft which has a screw shaft portion and an output shaft portion and which is connected to the driven portion so as to be able to rotate with respect thereto and which is disposed so as to be able to advance and retract, a nut which is threadingly engaged with the screw shaft portion, a motor frame which is installed on a motor installation frame, a rotor which is mounted on the output shaft portion, and a stator which is mounted on the motor frame.

In this case, the rotor is mounted on the output shaft portion of the transmission shaft, so the inner diameter of the stator can be decreased by that amount, and the outer diameter of the rotor can be decreased.

Accordingly, the inertia of the drive system can be decreased, so the acceleration of the driven portion can be increased, and the responsiveness of the driven portion at the time of start-up acceleration can be increased.

Moreover, the rotation which is generated by driving of the drive portion can be transmitted to the transmission shaft without using a spline, so the sliding resistance due to a spline can be eliminated. Accordingly, the efficiency of the drive portion can be increased.

### BRIEF DESCRIPTION OF THE DRAWINGS

FIG. 1 is a cross-sectional view showing a main portion of a conventional injection apparatus.

FIG. 2 is a cross-sectional view showing a main portion of an injection apparatus in a first embodiment of the present invention.

FIG 3 is a cross-sectional view showing a main portion of an injection apparatus in a second embodiment of the present invention.

FIG. 4 is a cross-sectional view showing a main portion of an injection apparatus in a third embodiment of the present invention.

FIG. 5 is a cross-sectional view showing a main portion of an injection apparatus in a fourth embodiment of the present invention.

### DESCRIPTION OF REFERENCE NUMERALS

12 screw

13 bearing box

18 front injection support

19 rear injection support

23 injection motor

35 output shaft

41 female spline

45 male spline

34, 54 frame

57, 157 stator

59, 159 stator core

63 ball nut

64 ball screw shaft portion

73, 173 position sensor

86, 186 rotor

91 ball screw shaft/output shaft unit

95 output shaft portion

### BEST MODE FOR CARRYING OUT THE INVENTION

The embodiments of the present invention will next be explained in detail with reference to the drawings.

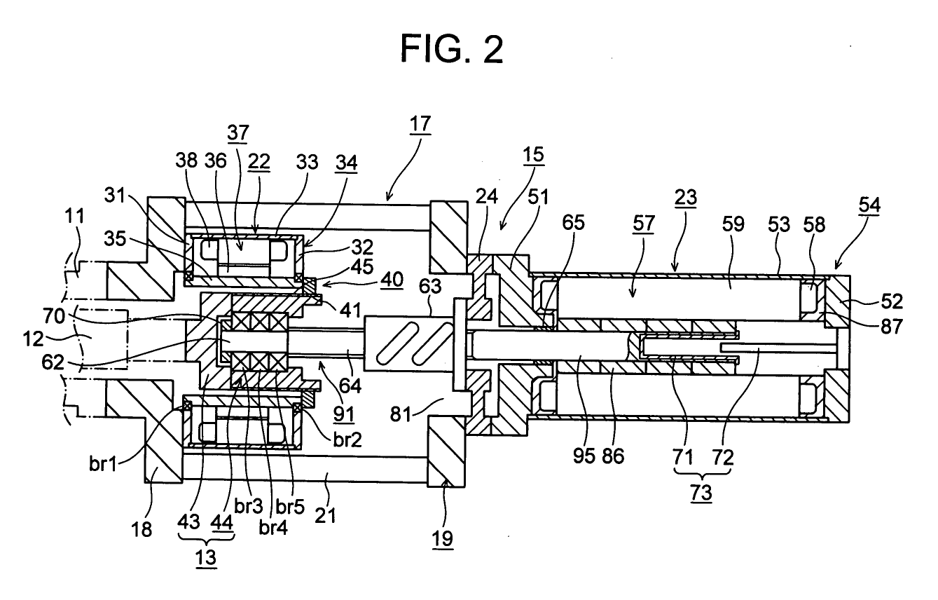

FIG. 2 is a cross-sectional view showing a main portion of an injection apparatus in a first embodiment of the present invention.

In the drawing, 11 is a heating cylinder (cylinder member). An unillustrated injection nozzle is installed at the front end (the left end in the drawing) of the heating cylinder 11. A screw 12 (driven portion and injection member) is disposed inside the heating cylinder 11 so as to be able to rotate and so as to be able to advance and retract (move to the left and right in the drawing).

The screw 12 has an unillustrated screw head at its front end, it extends to the rear (to the right in the drawing) inside the heating cylinder 11, and at its rear end (the right end in the drawing), it is secured to a bearing box 13. An unillustrated helical flight is formed on the other circumferential surface of the screw 12, and a groove is formed along the flight.

An unillustrated resin supply port is formed in a prescribed location of the heating cylinder 11. An unillustrated hopper is secured to the resin supply port. The resin supply port is formed in a location corresponding to the rear end portion of the groove in a state in which the screw 12 is positioned in its forwardmost position (towards the left in the drawing) inside the heating cylinder 11.

Accordingly, at the time of a metering step, if the screw 12 is rotated, a pellet-shaped resin (molding material) is supplied from the hopper, the resin is charged into the heating cylinder 11, and is caused to advance inside the groove. At the same time, the screw 12 is retracted (moved towards the right in the drawing).

An unillustrated heater is disposed around the heating cylinder 11, and the heating cylinder 11 can be heated by this heater to melt the resin within the groove. Accordingly, when the screw 12 is rotated and at the same time retracted by a prescribed amount, one shot of molten resin is accumulated at the front of the screw head.

At the time of an injection step, if the screw 12 is advanced (moved to the left in the drawing) without being rotated, resin accumulated at the front of the screw head is injected from the injection nozzle and fills a cavity in an unillustrated mold apparatus.

A drive portion 15 for rotating the screw 12 and advancing and retracting it is disposed to the rear of the heating cylinder 11. The drive portion 15 has an injection frame 17, a metering motor 22 (drive portion for metering) installed in the injection frame 17, an injection motor 23 (drive portion for injection) disposed to the rear of the injection frame 17, and other members. The screw 12, the metering motor 22, and the injection motor 23 are coaxially disposed.

The injection frame 17 has a front injection support 18, a rear injection support 19 which is disposed to the rear of the front injection support 18, and rods 21 which connect the front injection support 18 and the rear injection support 19 and provide a prescribed distance between the front injection support 18 and the rear injection support 19. The heating cylinder 11 is installed on the front end of the front injection support 18, and the metering motor 22 is installed on the rear end of the front injection support 18. The injection motor 23 is installed on the rear end of the rear injection support 19 through a load cell 24 (load sensor). The front injection support 18 acts as a motor installation frame for the metering motor 22, and the rear injection support 19 acts as a motor installation frame for the injection motor 23.

The metering motor 22 has a frame 34 which comprises a front flange 31, a rear flange 32, and a tubular frame 33 and which forms a motor frame for metering, a hollow output shaft 35 which is supported by bearings br1 and br2 for rotation with respect to the frame 34, a rotor 36 which is mounted on the output shaft 35, a stator 37 which is mounted on the frame 33 with a gap formed between it and the rotor 36, and other members. The metering motor 22 is attached to the injection frame 17 by securing the flange 31 to the front injection support 18. 38 is a stator coil. The metering motor 22 can be driven by supplying electric current to the stator coil 38.

At the time of a metering step, the screw 12 can be rotated by driving the metering motor 22. For this purpose, a spline nut 40 is mounted on the rear end of the output shaft 35, and a female spline 41 (first engaging element) is formed on the inner peripheral surface of the spline nut 40.

The bearing box 13 is disposed inside the output shaft 35, and has a disc-shaped bottom portion 43 which is mounted on the rear end of the screw 12, and a tubular side portion 44 which extends rearwardly from the outer peripheral rim of the bottom portion 43. Bearings br3-br5 are housed in the interior of the side portion 44. A male spline 45 (second engaging element) is formed on the outer peripheral surface of the side portion 44. The female spline 41 and the male spline 45 are engaged so as to be able to slide in the axial direction while being unable to rotate in the circumferential direction. They form a rotation transmitting portion.

At the time of metering step, rotation of the output shaft 35 generated by driving the metering motor 22 is transmitted to the bearing box 13 through the rotation transmitting portion, and the rotation received by the bearing box 13 is further transmitted to the screw 12. When the screw 12 is rotated, resin is supplied from the hopper, the resin enters the heating cylinder 11, and it advances within the groove. In accompaniment therewith, the screw 12 is retracted, and one shot of the resin accumulates in front of the screw head. At this time, the bearing box 13 is retracted with respect to the output shaft 35 with the female spline 41 and the male spline 45 engaged with each other. In this manner, metering can be carried out. When the screw 12 is retracted, a back pressure is applied to the screw 12 against the pressure generated by the resin.

The injection motor 23 comprises a frame 54 which comprises a front flange 51, a rear flange 52, and a tubular frame 53 and which constitutes a motor frame for injection, a rotor 86 which comprises a permanent magnet and which is rotatable with respect to the frame 54 and able to advance and retract, a stator 57 which is mounted on the frame 53 with a gap between it and the rotor 86, and other members. The injection motor 23 is attached to the injection frame 17 by securing the front flange 51 to the load cell 24. 58 is a stator coil, and 59 is a stator core. The injection motor 23 can be driven by supplying electric current to the stator coil 58.

At the time of an injection step, when the screw 12 is advanced without being rotated, by driving the injection motor 23, resin accumulated at the front of the screw head is injected from the injection nozzle and fills the cavity in the mold apparatus. For this purpose, a ball screw shaft/output shaft unit 91 (transmission shaft) is disposed at the rear end of the screw 12 via the bearing box 13 so as to be rotatable with respect to the screw 12, i.e., they are connected so as to be able to undergo relative rotation, and it is installed so as to be able to advance and retract.

A cylindrical shaft portion 62 is formed on the front end (the left end in the drawing) of the ball screw shaft/output shaft unit 91. The bearings br3-br5 inside the bearing box 13 rotatably support the cylindrical shaft portion 62 with respect to the side portion 44 and receive thrust loads. A ball screw shaft portion 64 (screw shaft portion) is integrally formed on the rear of cylindrical shaft portion 62, and an output shaft portion 95 is integrally formed at the rear of the ball screw shaft portion 64. The output shaft portion 95 functions as an output shaft of the injection motor 23. Therefore, the rotor 86 is bonded to the outer periphery of the output shaft-portion 95 over a prescribed distance forward of its rear end.

65 is a bushing which is disposed in a prescribed location (in the present embodiment, on the inner peripheral surface of a through hole in the front flange 51) and which rotatably and slidably supports the ball screw shaft/output shaft unit 91 with respect to the front flange 51. 70 is a nut which is secured to the ball screw shaft/output shaft unit 91 by threaded engagement with an unillustrated male thread formed on the outer peripheral surface of the ball screw shaft/output shaft unit 91 and which functions as a member for preventing the bearings br3-br5 from coming loose. The bushing 65 prevents a grease (lubricant) for lubricating the ball screw from penetrating into the frame 54 as the ball screw shaft/output shaft unit 91 advances and retracts and prevents it from adhering to the stator coil 58.

At its front end, the ball screw shaft/output shaft unit 91 is disposed inside the metering motor 22, it extends rearwardly through the rear injection support 19 and the load cell 24, and its rear end is disposed inside the injection motor 23. Therefore, a through hole 81 is formed in the rear injection support 19, and inside the through hole 81, a ball nut 63 (nut) is installed on the rear injection support 19 through the load cell 24, and the ball nut 63 is threadingly engaged with the ball screw shaft portion 64. A ball screw is constituted by the ball nut 63 and the ball screw shaft portion 64. The ball screw functions as a first movement direction converting portion which converts rotational movement into straight line movement accompanied by rotation, i.e., rotational and straight line movement. A first converting element is constituted by the ball nut 63, and a second converting element is constituted by the ball screw shaft portion 64. A roller screw can be used as a first movement direction converting portion instead of a ball screw. In this case, a roller nut is used instead of the ball nut 63 as a first converting element and a nut, and a roller screw shaft portion is used instead of the ball screw shaft portion 64 as a second converting element and a screw shaft portion. In this embodiment, the ball nut 63 is mounted on the rear injection support 19, but it can also be mounted on the frame 34.

In the injection motor 23, in order to detect the position of the ball screw shaft/output shaft unit 91, a position sensor 73 (position sensing portion) is disposed between the output shaft portion 95 of the ball screw shaft/output shaft unit 91 and the frame 54. For this purpose, a hole is formed in the output shaft portion 95 from the rear end extending forwards, a movable element 71 is disposed in the hole, and a stationary element 72 extends forwards from the rear flange 52 so that it can be inserted into and retracted from the movable element 71. The movable element 71 and the stationary element 72 are both slightly longer than the stroke of the screw 12 by the installation tolerance. In this embodiment, they have a length approximately 10 mm longer than the stroke, and they constitute a magnetic linear encoder for sensing the position of the screw 12. Namely, the stationary element 72 is constituted by a coil, and the movable element 71 has a structure in which a magnetic body and a non-magnetic body are alternatingly disposed. When the movable element 71 advances or retracts in a state in which the movable element 71 surrounds the stationary element 72, the magnetic field produced between the movable element 71 and the stationary element 72 changes, and the electrodes of the stationary element 72 change, so the position of the screw 12 can be detected. In this case, even if the output shaft portion 95 is rotated as the injection motor 23 is driven, the movable element 71 and the stationary element 72 do not interfere with each other, so the position of the ball screw shaft/output shaft unit 91 can be accurately detected.

At the time of an injection step, rotation of the output shaft portion 95 generated by driving the injection motor 23 is transmitted to the first movement direction converting portion, the rotational movement is converted into rotational and straight line movement by the first movement direction converting portion, and rotational and straight line movement is transmitted to the bearing box 13. The bearing box 13 is constructed so that the ball screw shaft/output shaft unit 91 is rotatably supported by at least three bearings br3-br5. Therefore, of the rotational and straight line movement which is transmitted to the bearing box 13, only the straight line movement is output, and the straight line movement is transmitted to the screw 12. A second movement direction converting portion is constituted by the bearing box 13.

As a result, when the injection motor 23 is driven, the ball screw shaft/output shaft unit 91 is caused to advance as it is rotated, the screw 12 is advanced without rotating, and injection can be carried out. When the injection motor 23 is rotated in the reverse direction, the screw 12 is retracted without rotating, and suck-back can be carried out.

As stated earlier, at least three bearings br3-br5 are disposed in the bearing box 13. A thrust load in the direction of advancement of the screw 12 is received by at least two of the bearings br4 and br5, and a thrust load in the direction of retraction of the screw 12 is received by the bearing br3. In this manner, the outer diameter of the components of the bearings br3-br5 which rotate together with the ball screw shaft portion 64 can be decreased. As a result, the rotational inertia of the bearing box 13, the rotor 86, the ball screw shaft/output shaft unit 91, and the like can be reduced.

When the above-described metering step is completed, the screw 12 is in the position for the completion of metering, suck-back is then carried out, the screw 12 is further slightly retracted, and it is placed in its rearmost position for the start of injection. When the injection step is then started, the screw 12 is advanced by the above-mentioned stroke, and it is moved to the forwardmost position corresponding to the completion of injection and the start of metering. In this embodiment, the ball screw shaft/output shaft unit 91 is advanced and retracted as the screw 12 is advanced and retracted, and the rotor 86 is also advanced and retracted.

In the injection step, during a period in which the injection motor 23 is driven and the screw 12 is advancing from the position for the start of injection to the position for the completion of injection, it is necessary for the magnetic flux generated by the stator 57 to be interlinked with the rotor 86. The axial length of the stator core 59 is set to be longer than the axial length of the rotor 86 by the stroke of the screw 12. At the backward limit position of the stroke of the screw 12, the rear end of the rotor 86 coincides with the rear end of the stator core 59, and at the forward limit position of the stroke of the screw 12, the front end of the rotor 86 coincides with the front of the stator core 59. The axial length of the stator core 59 determines the stator length, and the axial length of the rotor 86 determines the magnetic layer length.

A resin 87 fills the outer periphery of the stator coil 58, and the stator coil 58 is resin molded so that grease will not penetrate into the frame 54 and adhere to the stator coil 58 as the ball screw shaft/output shaft unit 91 advances and retracts. By adding a material having a high thermal conductivity such as a metal powder to the resin 87, heat which is generated in the stator coil 58 when the injection motor 23 is driven can be transmitted well and dissipated.

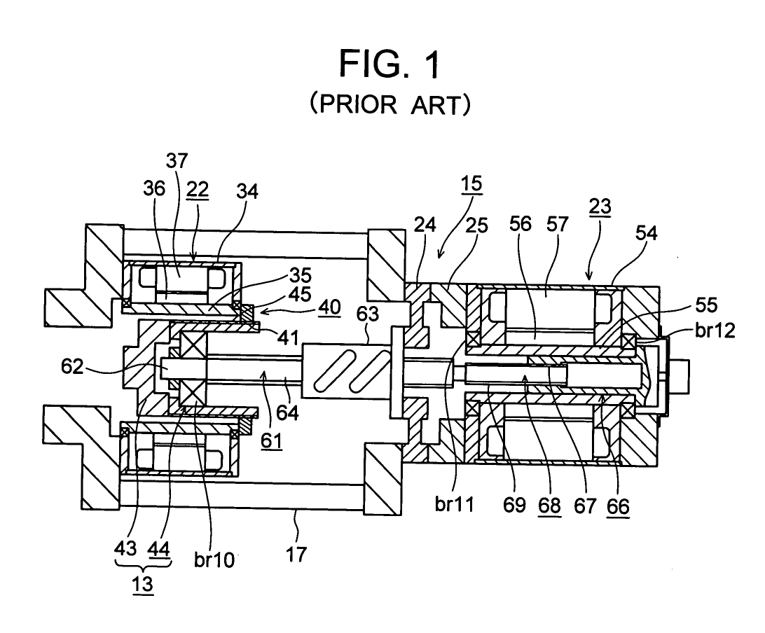

In this manner, the rotor 86 is directly installed on the solid output shaft portion 95 which is integrally formed with the ball screw shaft portion 64. As a result, a hollow output shaft 55 which was necessary between the inner peripheral edge of a stator 57 and a ball screw shaft portion 64 in a conventional injection apparatus (see FIG. 1), an engaging portion 66, and bearings br11 and br12 become unnecessary, so the inner diameter of the stator 57 can be reduced to this extent, and the outer diameter Dm of the rotor 86 can be decreased.

The torque T which is necessary in order to generate an injection force in an injection step is proportional to the square of the outer diameter Dm of the rotor 86, but the inertia J is proportional to the outer diameter Dm raised to the 4th power. Therefore, the acceleration α of the screw 12 can be increased to the extent that the inertia J is decreased. Namely, the acceleration α becomes
α∝ T/J
∝ Dm²/Dm⁴
∝ Dm⁻²
   so it decreases in proportion to the square of the outer diameter Dm.

In this manner, the inertia J of the drive system can be decreased and the acceleration α of the screw 12 can be increased, so the responsiveness of the start-up acceleration of the screw 12 can be increased. In order to decrease the outer diameter Dm, it is necessary to decrease the diameter of the ball screw shaft/output shaft unit 91. The lower limit of the outer diameter Dm is set to a level such that buckling of the ball screw shaft/output shaft unit 91 will not take place when an injection force is generated so as to advance the screw 12 during the injection step.

In addition, the weight of rotating portions can be reduced by an amount corresponding to the hollow output shaft 55, the engaging portion 66, and the bearings br11 and br12 which become unnecessary, so the inertia J can be further decreased, and the acceleration α can be further increased.

In addition, the number of parts can be decreased to the extent that the engaging portion 66 and the bearings br11 and br12 become unnecessary, so the cost of the injection apparatus can be decreased.

In addition, rotation which is generated by driving the injection motor 23 can be transmitted to the ball screw shaft/output shaft unit 91 without use of a spline, so the sliding resistance due to a spline can be eliminated. Accordingly, the efficiency of the injection motor 23 can be increased. The injection force generated at the time of an injection step is sensed by the load cell 24. When there is sliding resistance due to a spline, the measuring accuracy of the injection force by the load cell 24 ends up being low. Therefore, in the past, in order to reduce the influence of the sliding resistance due to a spline, a load cell retainer 25 was installed between the load cell 24 and the injection motor 23. However, in this embodiment, there is no sliding resistance due to a spline, and the measuring accuracy of the injection force by the load cell 24 is high, so it is not necessary to use a load cell retainer 25, and the injection motor 23 can be directly installed on the load cell 24. Accordingly, the structure of the injection apparatus can be simplified.

The ball screw shaft/output shaft unit 91 is operated by a shaft rotation/shaft movement type of operating method in which rotation and linear movement take place simultaneously. A reaction force when the driven member is advanced is only applied to a portion of the ball screw shaft/output shaft unit 91 located forward of the ball nut 63, and a reaction force does not act to a portion of the ball screw shaft/output shaft unit 91 located rearward of the ball nut 63. Accordingly, the outer diameter Dm of the shaft can be decreased compared to a type in which buckling occurs in the overall shaft. In addition, the ball screw shaft/output shaft unit 91 is rotationally supported by the ball nut 63, so bearings can be omitted. The rotor 86 is indirectly supported by a magnetic flux generated by the stator 57.

Next, a second embodiment of the present invention will be explained. Portions having the same structure as in the first embodiment are affixed with the same symbols and an explanation thereof will be omitted. Due to having the same structure, they provide the same effects of the present invention as in the first embodiment.

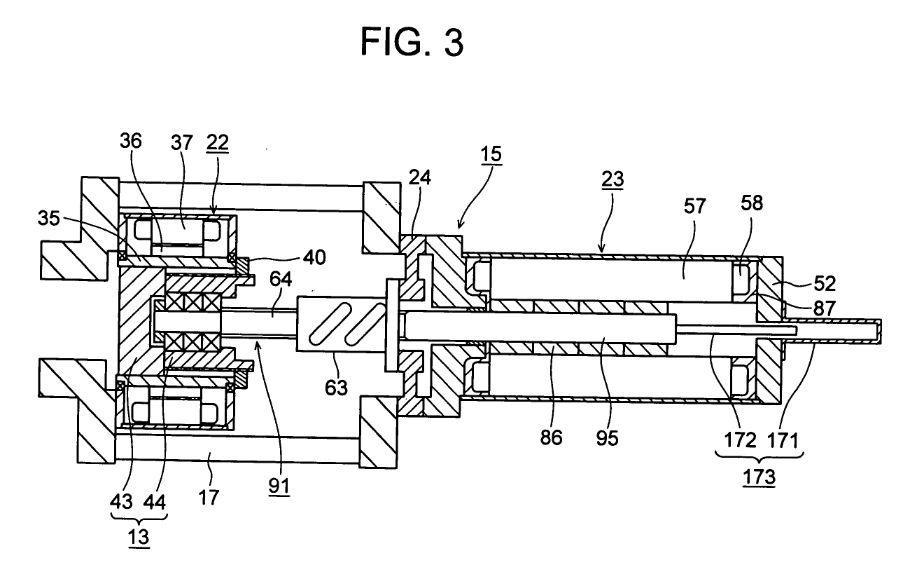

FIG. 3 is a cross-sectional view showing a main portion of an injection apparatus in the second embodiment of the present invention.

In this case, 173 is a position sensor (position sensing portion) for sensing the position of a ball screw shaft/output shaft unit 91 (transmission shaft). The position sensor 173 has a stationary element 171 which extends rearwards (to the right in the drawing) from the above-described rear flange 52 and a movable element 172 which extends rearwards from the rear end (the right end in the drawing) of the output shaft portion 95. The movable element 172 passes through the rear flange 52 and extends rearwards, and it can be inserted into and withdrawn from the stationary element 171. The stationary element 171 and the movable element 172 both have dimensions slightly longer than the stroke of a screw 12 (driven portion and injection member) (FIG. 2), and they form a linear encoder.

In this case, it is not necessary to form a hole in the output shaft 95 for housing the stationary element 171, so the diameter of the ball screw shaft/output shaft unit 91 can be reduced to that extent. Moreover, the stationary element 171 is disoised so as to extend rearwardly from the rear flange 52, and the movable element 172 is disposed to extend rearwardly from the rear end of the output shaft 95, so maintenance of the position sensor 173 can be easily carried out.

The position of the ball screw shaft/output shaft unit 91 is sensed at a location spaced from the rotor 86 and the stator coil 58, so it is possible to prevent the application of noise to the position sensor 173. Accordingly, the sensing accuracy of the position sensor 173 can be increased.

Next, a third embodiment of the present invention will be explained. Portions having the same structure as in the first embodiment are affixed with the same symbols, so an explanation thereof will be omitted. Due to having the same structure, they provide the same effects of the present invention as in the first embodiment.

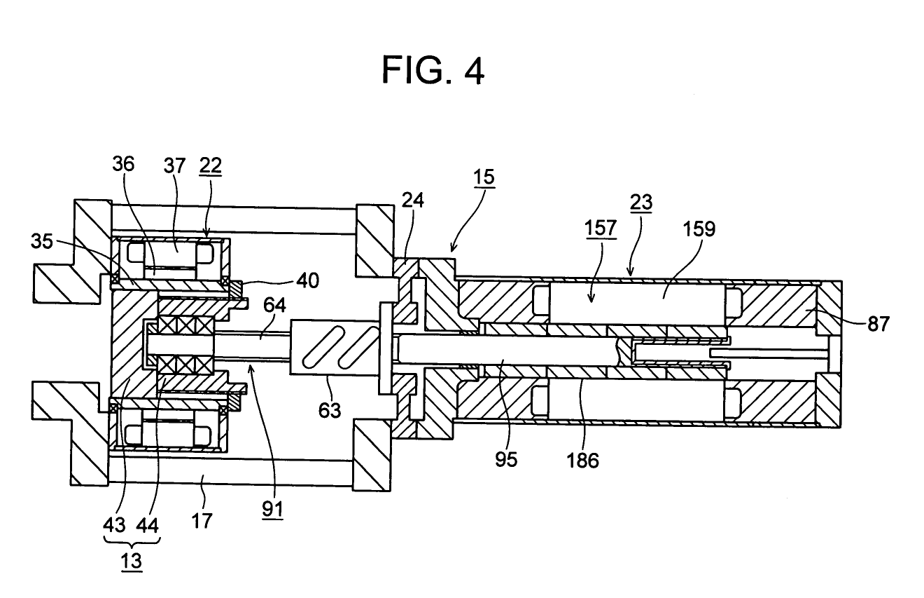

FIG. 4 is a cross-sectional view showing a main portion of an injection apparatus in the third embodiment of the present invention.

In this case, in an injection step, during the period in which an injection motor 23 (drive portion for injection) is driven and a screw 12 (driven portion and injection member) (FIG. 2) is advanced from a position for the start of injection (injection start position) to a position for the completion of injection (injection completion position), it is necessary for the magnetic flux generated in a stator 157 to be interlinked with a rotor 186. The axial length of the rotor 186 is set to be longer than the axial length of the stator core 159 by at least the stroke of the screw 12. In the injection start position of the screw 12, the front end of the rotor 186 (the left end in the drawing) coincides with the front end of the stator coil 159, and in the injection completion position of the screw 12, the rear end of the rotor 186 (the right end in the drawing) coincides with the rear end of the stator core 159.

In this case, the axial length of the stator 157 can be decreased, so the operation of winding the stator coil on the stator core 159 can be simplified, and the axial length of the rotor 186 can be easily set.

Next, a fourth embodiment of the present invention will be explained. Portions having the same structure as in the second embodiment are affixed with the same symbols, so an explanation thereof will be omitted. Due to having the same structure, they provide the same effects of the present invention as in the second embodiment.

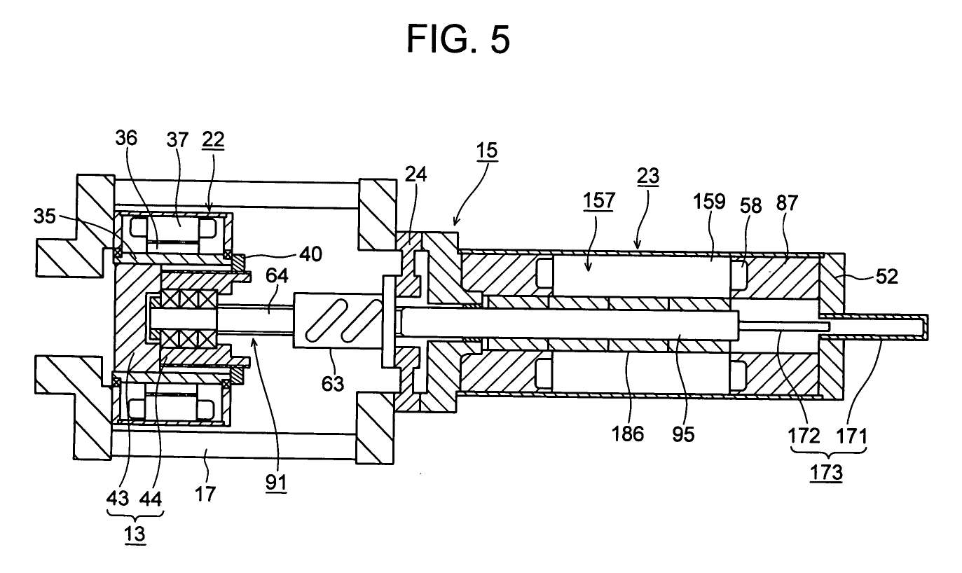

FIG. 5 is a cross-sectional view showing a main portion of an injection apparatus of the fourth embodiment of the present invention.

In this case, 173 is a position sensor (position sensing portion) for sensing the position of a ball screw shaft/output shaft unit 91 (transmission shaft). The position sensor 173 has a stationary element 171 which extends rearwardly (to the right in the drawing) from the above-described rear flange 52, and a movable element 172 which extends rearwardly from the rear end (the right end in the drawing) of the output shaft 95. The movable element 172 passes through the rear flange 52 and extends rearwardly, and it can be freely inserted into and withdrawn from the stationary element 171. The stationary element 171 and the movable element 172 both have dimensions which are slightly longer than the stroke of a screw 12 (driven member and injection member) (FIG. 2), and they form a magnetic linear encoder.

In this case, it is not necessary to form a hole in the output shaft portion 95 for housing the stationary element 171, so the diameter of the ball screw shaft/output shaft unit 91 can be decreased to this extent. Moreover, the stationary element 171 is disposed so as to extend rearwardly from the rear flange 52, and the movable element 172 is disposed so as to extend rearwardly from the rear end of the output shaft, portion 95, so maintenance of the position sensor 173 can be easily carried out.

In addition, the position of the ball screw shaft/output shaft unit 91 is sensed at a location spaced from the rotor 186.and the stator coil 58, so it is possible to prevent noise from being applied to the position sensor 173. Accordingly, the sensing accuracy of the position 173 can be increased.

The axial length of the stator 157 can be decreased, so the operation of winding the stator coil on the stator core 159 can be simplified, and the axial length of the rotor 186 can be easily set.

In each of the above-described embodiments, a bearing box 13 is disposed inside an output shaft 35, and rotations generated by driving of a metering motor 22 are transmitted to the bearing box 13 through an output shaft 35, but it is also possible to dispose a rotation transmitting system such as gears between the metering motor 22 and the bearing box 13.

In each of the above-described embodiments, an injection apparatus was described, but the present invention is not limited thereto, and it can also be applied to a mold clamping apparatus, for example. In this case, the mold clamping apparatus has a structure in which a stationary platen and a toggle support are linked by a plurality of tie bars, a movable platen is slidably supported on the tie bars, and a toggle mechanism is disposed between the movable platen and the toggle support. A front flange of a mold clamping motor (drive portion for mold clamping) is secured to the rear end of the toggle support (the side away from the toggle mechanism), a ball nut is secured to the front end (the side facing the toggle mechanism), and the end portion of a ball screw shaft/output shaft unit which passes through the toggle support is rotatably connected to a crosshead (driven portion) of the toggle mechanism. By advancing the ball screw shaft/output shaft unit, in a straight line, mold closing, mold clamping, and mold opening of a mold apparatus can be carried out. In the mold clamping apparatus, a movable platen (driven member) can be directly rotatably connected to the end portion of the ball screw shaft/output shaft unit. In addition, a hole larger than the ball nut can be formed in the toggle support, and the ball nut can be secured to the front flange of the mold clamping motor.

The present invention is not limited to the above-described embodiments. Numerous modifications and variations of the present invention are possible in light of the spirit of the present invention, and they are not excluded from the scope of the present invention.

### INDUSTRIAL APPLICABILITY

The present invention can be applied to an injection apparatus of an injection molding machine.

1. A drive apparatus for an injection molding machine characterized by comprising:
(a) a driven portion;
(b) a transmission shaft having a screw shaft portion and an output shaft portion and which is connected to the driven portion so as to be rotatable with respect thereto and which is able to advance and retract;
(c) a nut which is threadingly engaged with the screw shaft portion;
(d) a motor frame which is mounted on a motor mounting frame;
(e) a rotor which is mounted on the output shaft portion; and
(f) a stator which is mounted on the motor frame.

2. A drive apparatus for an injection molding machine as set forth in claim 1, wherein the rotor is a permanent magnet.

3. A drive apparatus for an injection molding machine as set forth in claim 1, wherein one of the axial length of the stator core and the axial length of the rotor is longer than the other by at least the stroke of the transmission shaft.

4. A drive apparatus for an injection molding machine as set forth in claim 1, wherein the nut is secured to one of the motor frame and the motor mounting frame.

5. A drive apparatus for an injection molding machine as set forth in claim 1, wherein a position sensing portion is disposed between the output shaft portion and the motor frame.

6. A drive apparatus for an injection molding machine as set forth in claim 1, wherein the periphery of a stator coil of the stator is filled with a resin.

7. A drive apparatus for an injection molding machine as set forth in claim 1, wherein
(a) the driven portion is a screw;
(b) the motor frame is a motor frame for injection; and
(c) the screw and the transmission shaft are connected through a bearing box.

8. A drive apparatus for an injection molding machine as set forth in claim 7, wherein
(a) the bearing box is disposed inside a hollow output shaft of a metering motor; and
(b) rotation of the output shaft is transmitted to the bearing box through a rotation transmitting portion.

9. A drive apparatus for an injection molding machine as set forth in claim 1, wherein
(a) the driven portion is a crosshead of a toggle mechanism; and
(b) the motor frame is a motor frame for mold clamping.

10. A drive apparatus for an injection molding machine as set forth in claim 1, wherein
(a) the driven portion is a movable platen; and
(b) the motor frame is a motor frame for mold clamping.

11. A molding method using an injection molding machine comprising a driven portion and a drive portion equipped with a transmission shaft having a screw shaft portion and an output shaft portion and connected to the driven portion so as to be able to rotate with respect thereto and which is able to advance and retract, a nut threadingly engaged with the screw shaft portion, a motor frame mounted on a motor mounting frame, a stator mounted on the motor frame, and a rotor mounted on the output shaft portion, characterized by:
(a) advancing and retracting the rotor by driving the drive portion and rotating the rotor; and
(b) advancing and retracting the driven portion by advancing and retracting the transmission shaft.

12. A molding method as set forth in claim 11, wherein one of the axial length of the stator core and the axial length of the rotor is longer than the other by at least the stroke of the transmission shaft.

13. A molding method as set forth in claim 11, wherein the position of the driven portion is sensed between the output shaft portion and the motor frame.
